(19) United States
(12) Patent Application Publication
(10) Pub. No.: US 2024/0416259 A1
(43) Pub. Date: Dec. 19, 2024

(54) COLUMN FLOW DAMPENER FOR MALS NOISE REDUCTION DURING SEC-MALS ANALYSIS

(71) Applicant: Waters Technologies Corporation, Milford, MA (US)

(72) Inventors: Lavelay Kizekai, Coventry, RI (US); Michael Dion, Whitinsville, MA (US); Stephen Shiner, Holden, MA (US); Balasubrahmanyam Addepalli, Hopkinton, MA (US); Matthew A. Lauber, North Smithfield, RI (US)

(73) Assignee: Waters Technologies Corporation, Milford, MA (US)

(21) Appl. No.: 18/742,319

(22) Filed: Jun. 13, 2024

Related U.S. Application Data
(60) Provisional application No. 63/510,241, filed on Jun. 26, 2023.
(60) Provisional application No. 63/472,974, filed on Jun. 14, 2023.

(51) Int. Cl. B01D 15/34; G01N 21/47

(52) U.S. Cl. CPC B01D 15/34; G01N 21/47; G01N 2021/4711

(57) ABSTRACT

The present technology provides a description of a flow column dampener device capable of decreasing the MALS noise from solvent contaminants and transient ripples induced by the HPLC pump prior to the evaluation and characterization of the biophysical properties of macromolecules. This dampener typically includes a particle bed column that can trap and remove the noise-inducing soluble particulates from mobile phase, while simultaneously dampening the noise induced by pump-induced ripples. The types of sorbents, sorbent particle size range and column size formats of the device provides significant reduction in MALS noise prior to the evaluation. This device enables confident characterization of cell and gene therapy products with accurate measurements of the physical properties of the macromolecule analytes such as cell and gene therapy products.

### CROSS-REFERENCE TO RELATED APPLICATIONS

The present application claims priority to and the benefit of U.S. Provisional Application Ser. No. 63/472,974, entitled “Column flow dampener for MALS noise reduction during SEC-MALS analysis”, and filed on Jun. 14, 2023 and U.S. Provisional Application Ser. No. 63/510,241, entitled “Column flow dampener for MALS noise reduction during SEC-MALS analysis”, and filed on Jun. 26, 2023. The contents of both applications are hereby incorporated by reference in their entirety.

### FIELD OF THE TECHNOLOGY

The present disclosure relates to the use of a mobile phase dampening device during chromatographic analysis.

### BACKGROUND

Absolute physical properties (size, molar mass, etc.) of macromolecules (biotherapeutics, proteins, polymers) are often measured by a combination of size exclusion chromatography and multi-angle light scattering (SEC-MALS) technique. Contaminants in the SEC mobile phase obscure meaningful signals of macromolecules by causing light scattering (LS) baseline noise and drifting. Besides fouling the flow cell, the contaminants cause elevated offset voltage at each angle for the plain mobile phase. This leads to excessive drift, wander, increased baseline voltage, RMS baseline noise, potential pressure issues, poor separation of analytes (through interference) and uncertainty in measurements of the analyte physical properties due to decreased signal-to-noise ratio. Controlling the noise contributing factors prior to the evaluation column is desired so that this noise will not interfere with the on-column separation of biomolecules.

### SUMMARY

The problems associated with controlling noise in a chromatography system are mitigated by the use of a dampener that acts as a trap and prevent the contaminants and transient ripples from the pumps from reaching or bleeding into the chromatographic column and detector. In an embodiment, a particle bed column can be used as a dampener. The particle bed column is selected to tolerate different pH ranges and should not get dissolved in the mobile phase. A particle bed column with these features can clear the noise causing interferences by trapping them, while impeding the transient ripples induced by the pump to reduce the contribution to PDMALS noise. The dampener is placed just before the column, so that both particulate and mechanical interferences can be removed.

In one aspect, the present technology is directed to a chromatographic system comprising: one or more mobile phase pumps; a sample injector fluidically coupled through a flow path to the one or more mobile phase pumps; a dampener positioned in the flow path between the one or more mobile phase pumps and the sample injection device; a chromatographic column comprising an inlet and an outlet, wherein the inlet of the chromatographic column is fluidically coupled to the sample injection device; and a detector coupled to the outlet of the chromatographic column.

The above aspect can include one or more of the following features. In an embodiment, the dampener comprises one or more particle bed columns comprising packed particles. The particles can be hydrophilic particles. In an embodiment, the particles the particles have a particle size from about 1.7 μm to about 30 μm. In some embodiments, the particle size is about 2.0 μm to about 30 μm. In certain embodiments, the particle size is about 3.0 μm to about 20 μm.

In an embodiment, the particle bed column has an inner diameter from about 2 mm to about 5 mm. In an embodiment, the particle bed column has a length from about 5 mm to about 30 mm.

In an embodiment, the chromatographic column comprises a size exclusion chromatography (SEC) sorbent.

In an embodiment, the detector is a multi-angle light scattering (MALS) detector. In an embodiment, the dampener is configured to reduce RMS baseline noise of the mobile phase to less than 100 μV or less than 30 μV.

In an embodiment, the chromatographic system further comprises a heater in thermal communication with the chromatographic column.

In another aspect, the present technology is directed to a method of performing chromatography on a sample. The method of this aspect includes passing the sample through a chromatography system as described herein. In an embodiment, the sample is a macromolecule and the chromatographic column is a SEC column. In an embodiment, the sample is a biological polymer (e.g., a protein).

In an embodiment, a sample is passed through a chromatographic system, having a dampener, a SEC column, and a MALS detector.

### BRIEF DESCRIPTION OF THE DRAWINGS

The technology will be more fully understood from the following detailed description taken in conjunction with the accompanying drawings, in which:

FIG. 1 is a schematic of a chromatographic flow system including a chromatography column and various other components, in accordance with an illustrative embodiment of the technology.

FIG. 2 is a picture of an ACQUITY™ UPLC™ H-class Bio System fitted with a dampener.

FIG. 3 depicts the baseline voltage of MALS detector in a chromatography system without a dampener.

FIG. 4 depicts the baseline voltage of MALS detector in a chromatography system with a dampener.

FIG. 5 depicts a comparison of the MALS noise obtained without or with the use of dampener.

FIG. 6 is an overlay example chromatogram, with and without a dampener located prior to the evaluation column.

### DETAILED DESCRIPTION

Size exclusion chromatography (SEC) is a type of chromatography in which the analytes in a mixture are separated or isolated on the basis of hydrodynamic radius. In SEC, separation occurs because of the differences in the ability of analytes to probe the volume of the porous stationary phase media. SEC is typically used for the separation of large molecules or complexes of molecules (“macromolecules). For example, without limitation, many large molecules of biological origin (“biological polymers”), such as deoxyribonucleic acids (DNAs), ribonucleic acids (RNAs), proteins, antibodies, polysaccharides, antibody-drug conjugates, and fragments and complexes of any thereof are analyzed by SEC. Synthetic polymers, plastics, and the like are also typically analyzed by SEC.

SEC is normally performed using a column having a packed bed of particles. The packed bed of particles is a separation media or stationary phase through which the mobile phase will flow. The column is placed in fluid communication with a pump and a sample injector. The sample is loaded into the column under pressure by the sample injector and the sample components and mobile phase are pushed through the column by the pump. The components in the sample leave or elute from the column with the largest molecules (largest hydrodynamic radius) exiting first and the smallest molecules leaving last.

The SEC column is placed in fluid communication with a detector, which can detect the change in the nature of the mobile phase as the mobile phase exits the column. The detector will register and record these changes as a plot, referred to as a chromatogram, which is used to determine the presence or absence of the analyte, and, in some embodiments, the concentration thereof. The time at which the analyte leaves the column (retention time) is an indication of the size of the molecule. Molecular weight of the molecules can be estimated using standard calibration curves. Examples of detectors used for SEC and anion exchange chromatography are, without limitation, refractive index detectors, UV detectors, light-scattering detectors, and mass spectrometers.

Multi-angle light scattering (MALS) detection is particularly useful for detecting macromolecules. MALS detectors are sensitive to particles with molecular weights ranging from 200 Da to 1 billion Da based on their scattering light. During MALS detection a polarized light beam with a single frequency illuminates a solution of macromolecules or nanoparticles of interest. During this interaction, the oscillating electromagnetic wave of incident light induces an oscillating dipole in the electronic cloud of the molecule. The electric field of incident light beam is set in such a way that it is perpendicular (vertical plane) to the intensity and angular dependence of the measured scattered light (horizontal plane). While the intensity measurement provides molar mass information, the angular dependence presents the size information. During these measurements, baseline signal from a 90-degree detector is used to measure the peak-to-peak voltage and the RMS (root mean square) noise (obtained by dividing the peak-to-peak voltage by 6.6). Apart from the contaminants, the detector is also sensitive to the transient ripples induced by pump contributing to the overall MALS noise.

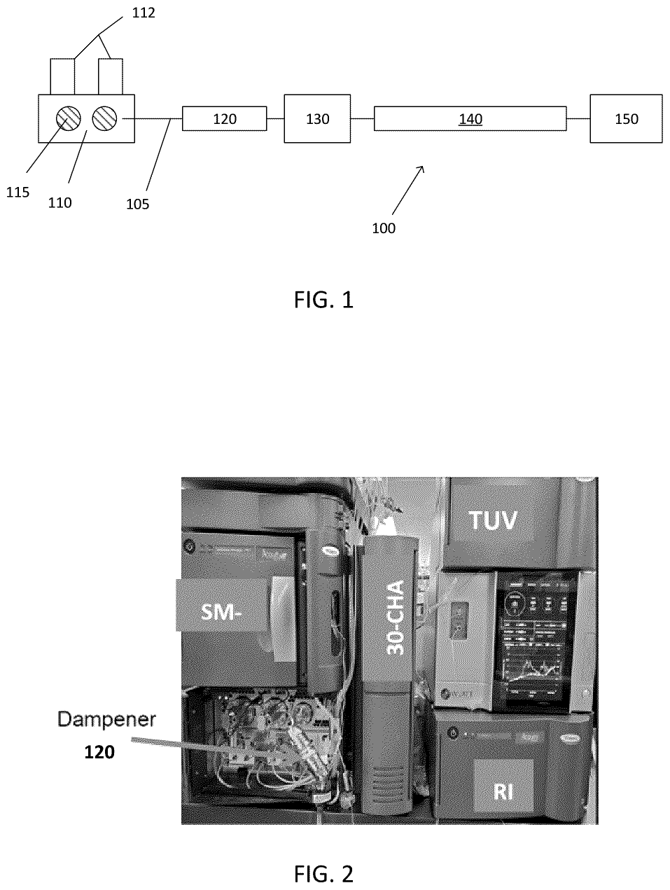

FIG. 1 is a representative schematic of a chromatographic system 100 that can be used to separate analytes in a sample. Chromatographic system 100 includes several components including: a fluid manager system 110 (which controls mobile phase flow through the system); a dampener 120; a sample injector 130; a chromatographic column 140; a detector 150; and tubing 105, fluidically coupling the components. An exemplary chromatographic system is an ACQUITY™ UPLC™ H-class Bio System (available from Waters Technology Corporation, Milford, MA), depicted in FIG. 2, which comprises a Quaternary Solvent Manager (SM) fitted with 100 μL mixer and dampener (120 position indicated by arrow), FTN sample manager, column heater (30-CHA), TUV, MALS (Wyatt DAWN™ MALS detector), and refractive index (RI) detectors.

The fluid manager system 110 comprises one or more solvent reservoirs 112 fluidically coupled to one or more pumps 115. During use, the mobile phase is pumped into the system 100 by one or more mobile phase pumps 115 and flows into dampener 120. The mobile phase pump 115 can be a solvent pump that can be used for ultra-high performance liquid chromatography. For example, the mobile phase pump can be capable of producing a flow rate of the mobile phase into the chromatography system of up to about 1 mL/min of mobile phase at a maximum pressure of about 1034 bar.

Myriad pump configurations are known which deliver fluid at high pressure for use in liquid chromatography applications. High pressure fluid delivery mobile phase pumps generally incorporate at least one plunger or piston which is reciprocated within a pump chamber into which fluid is introduced. A controlled reciprocation frequency and stroke length of the plunger within the pump chamber determines the flow rate of fluid output from the mobile phase pump. However, the assembly for driving the plunger is an elaborate combination of elements that can introduce undesirable motion in the plunger as it is driven, which motion makes it difficult to precisely control the solvent delivery system output and results in what is termed “noise” or detectable perturbations in a chromatographic baseline. Much of this noise does not result from random statistical variation in the system, rather much of it is a function of a mechanical “signature” of the mobile phase pump. The mechanical signature of a mobile phase pump is correlated to mechanically related phenomena such as anomalies in ball and screw drives, gears, and/or other components used in the pump to affect the linear motion that drives the piston(s). Other factors creating noise from the mobile phase pump include physical phenomena such as the onset or completion of solvent compression, or the onset of solvent delivery from the pump chamber.

To mitigate the noise created by the mobile phase pump, a dampener 120 is positioned in the flow path between the one or more mobile phase pumps 110 and the sample injection device 120. A dampener can be configured to reduce noise created by the mechanical signature of the pump. A dampener can also be configured to prevent contaminants in the mobile phase from reaching the chromatographic column. In an embodiment, the dampener 120 is a particle bed column that includes packed particles. The particle bed column acts as a trap and prevent the contaminants and transient ripples reaching or bleeding into the chromatographic column.

When a MALS detector is used, the dampener can reduce the baseline noise. For example, the dampener can be configured to reduce RMS baseline noise of the mobile phase to less than 100 μV or less than 30 μV in a MALS detector.

In a specific embodiment, the particles used in the particle bed column have a particle size from about 1.7 μm to about 30 μm (e.g., about 2 μm to about 30 μm; about 3 μm to about 20 μm). Generally, the smaller the particle size, the greater the noise reduction produced by the dampener. However, as the particle size of the particles in the dampener is reduced, the pressure required to pump the mobile phase through the dampener is increased. The selection of the particle size used in the dampener may need to be balanced with the desired pressure of the mobile phase. The particles may be packed in a column having an internal diameter from about 2 mm to about 5 mm. The particle bed column can have a length from about 5 mm to about 30 mm. Exemplary column dimensions that can be used for the particle bed column dampener include 2.1 mm×5 mm, 4.6 mm×20 mm, and 4.6 mm×30 mm. The dampener may be composed of a single particle bed column, or two or more particle bed columns coupled in series. These dampeners (e.g., packed bed column) typically have a frit such as a 0.2 μm frit.

The particles used in the particle bed columns are selected to tolerate different pH ranges and should not get dissolved in the mobile phase. In some embodiments, the particles are hydrophilic particles. Exemplary particles used in the particle bed columns include BEH™ amide particles (HILIC, such as ACQUITY™ BEH™ amide sorbent particles available from Waters Technologies Corporation) or Oasis™ HLB particles (hydrophilic lipophilic copolymer, available from Waters Technologies Corporation). Another exemplary particle that can be used in the particle bed column is XBridge™ BEH™ C18 particles (available from Waters Technologies Corporation).

The dampener (e.g., dampener 120) is fluidically coupled to the pumps of the fluid manager system and the sample injector. During use, a pressurized mobile phase flow stream, produced by the pumps flows through the dampener and into the sample injector. The sample injector is a device that is capable introducing a sample into the mobile phase flow stream upstream from the chromatographic column. In embodiments where a sample manager is used, the sample manager can include, for example, a plurality of sample vials which are individually injected into the mobile phase flow stream. An exemplary sample manager system is the FTN (Flow Through Needle) sample manager (available from Waters technologies Corporation).

Any kind of chromatographic column can benefit from the use of an upstream dampener. The use of a dampener is particularly beneficial for SEC chromatographic columns. Size exclusion chromatography (SEC) utilizes a stationary phase material with a size-based affinity for the analyte. In some embodiments, the stationary phase material comprises porous particles having a surface, wherein at least some substantial portion thereof is modified with a hydroxy-terminated polyethylene glycol (PEG). The modified porous particles may be silica or inorganic-organic hybrid particles. A particularly suitable hydroxy-terminated PEG modified porous particle is that described in U.S. patent application Ser. No. 17/502,483 to DeLano et al. (US 2022-0118443, published Apr. 21, 2022), and Ser. No. 17/477,340 to Sarisozen et al. (US 2022-0080388 published Mar. 17, 2022), each of which is incorporated herein by reference in its entirety and for all purposes. An exemplary SEC chromatographic column is an XBridge™ BEH™ 450 Å 2.5 μm Premier GTx Column 4.6×150 mm (available from Waters Technologies Corporation).

For use in SEC, generally, the stationary phase will be immobilized in a housing having a wall defining a chamber, for example, a column having an interior for accepting the stationary phase. Such columns will have a length and a diameter. In some embodiments, the length of the column is about 300 mm. In some embodiments, the length of the column is about 150 mm. In some embodiments, the length of the column is less than about 300 mm, less than about 150 mm, less than about 100 mm, or less than about 50 mm. In some embodiments, the length of the column is about 50 mm, about 30 mm, about 20 mm, or about 10 mm. In some embodiments, the column has a bore size of about 4.6 mm inside diameter (i.d.). In some embodiments, the column has a bore size of greater than 4.6 mm i.d. In some embodiments, the column has a bore size of about 7.8 mm i.d. In some embodiments, the column has a bore size of greater than 7.8 mm i.d. In some embodiments, the column has a bore size of greater than about 4 mm i.d., greater than about 5 mm i.d., greater than about 6 mm i.d., or greater than about 7 mm i.d.

The chromatographic method generally comprises contacting a sample containing at least one analyte with an immobilized stationary phase material as described herein (e.g., in an SEC chromatographic column as described herein), flowing a mobile phase through the stationary phase material for a period of time; and eluting the at least one analyte from the immobilized stationary phase in the mobile phase.

The method disclosed herein utilizes a sample containing at least one analyte such as a macromolecule or biological polymer. In some embodiments, the biological polymer is a nucleic acid (e.g., RNA, DNA, oligonucleotide), protein (e.g., fusion protein), peptide, antibody (e.g., monoclonal antibody (mAb)), antibody-drug conjugate (ADC), polysaccharides, virus, virus-like particle, viral vector (e.g., gene therapy viral vector, adeno-associated viral vector), biosimilar, or any combination thereof. In some embodiments, the at least one analyte comprises a nucleic acid which is an RNA, such as mRNA. In some embodiments, the analyte is a protein-free RNA.

The method for performing SEC as disclosed herein comprises flowing a mobile phase through an immobilized stationary phase as described herein for a period of time. The mobile phase generally comprises water, an organic co-solvent, a buffer, and optionally one or more salts. In certain specific embodiments, the mobile phase and, optionally the sample, are provided by a high-performance liquid chromatography (HPLC) system.

Buffers serve to control the ionic strength and the pH of the mobile phase. Many different substances may be used as buffers depending on the nature of the analyte. Non-limiting examples of suitable buffers include phosphates, tris (hydroxymethyl) aminomethane, and acetates. In some embodiments, the buffer comprises phosphate. In some embodiments, the buffer comprises acetate. In some embodiments, the buffer is ammonium acetate. In some embodiments, the buffer is an alkali metal phosphate. In some embodiments, the buffer is a sodium or potassium phosphate. In some embodiments, the buffer is sodium phosphate monobasic, sodium phosphate dibasic, or a combination thereof.

The concentration of the buffer may vary depending on the desired pH and ionic strength of the mobile phase. In some embodiments, the buffer is present at a concentration from about 5 to about 500 mM, such as from about 5, about 10, about 20, about 20, about 40, about 50, about 60, about 70, about 80, about 90, or about 100 mM, to about 200, about 300, about 400, or about 500 mM.

The pH of the mobile phase may vary. In some embodiments, the pH value of the mobile phase is from about 5.0 to about 10.0, such as from about 5.0 to about 8.0. In some embodiments, the pH value of the mobile phase is from about 6.0 to about 7.5. In some embodiments, the pH is from about 6.0, or about 6.5, to about 7.0, or about 7.5. In some embodiments, the pH is about 6.0, about 6.1, about 6.2, about 6.3, about 6.4, about 6.5, about 6.6, about 6.7, about 6.8, about 6.9, about 7.0, about 7.1, about 7.2, about 7.3, about 7.4, or about 7.5. In some embodiments, the pH is about 7.0

In some embodiments, the mobile phase comprises a salt. As used herein, the term “salt” refers to an ionic compound comprising an alkali or alkaline earth metal and a halogen (e.g., fluoride, chloride, bromide, iodide). Undesired interactions can be mitigated through utilizing a salt to reduce ionic secondary interactions. However, increasing the salt concentration can induce aggregation and thus lead to a decrease in native monomer, and the addition of high concentrations of salt can exacerbate hydrophobic interactions, and complicates mobile phase optimization. When present, suitable salts include, but are not limited to, sodium chloride and potassium chloride. Suitable concentrations of salts in the mobile phase may range from about 10 to about 500 mM.

In some embodiments, the mobile phase comprises an organic co-solvent. Organic co-solvents such as methanol, ethanol, isopropanol or acetonitrile are common additives to SEC mobile phases. When present, a co-solvent, such as acetonitrile, is generally present at less than about 15% by volume in the mobile phase. In some embodiments, the mobile phase comprises an organic co-solvent in an amount up to about 15% by volume in the mobile phase. In some embodiments, the co-solvent is acetonitrile. In some embodiments, the acetonitrile is present in an amount from about 5 to about 15% by volume.

The separation method as disclosed herein may be conducted by flowing the mobile phase through the stationary phase at a variety of different flow rates, which may be determined by one of skill in the art based on scale, stationary phase particle size, difficulty of separation, and the like. In some embodiments, flowing the mobile phase through the immobilized stationary phase is performed at a flow rate from about 0.1 mL/min to about 3 mL/min. In certain embodiments, the flow rate is about 1 mL/min. In some embodiments, the flow rate is about 2 mL/min. In some embodiments, the flow rate is about 3 mL/min. In some embodiments, the flow rate is less than 1 mL/min, such as from about 0.05, about 0.1, about 0.2, about 0.3, about 0.4, or about 0.5, to about 0.6, about 0.7, about 0.8, about 0.9, or about 1 mL/min. In some embodiments, the flow rate is about 0.35 mL/min.

In an embodiment, the chromatographic system further comprises a heater in thermal communication with the chromatographic column. The heater can be used to maintain the temperature at which the chromatography is performed at a predetermined temperature. In some embodiments, the column temperature may be maintained from about 20 to about 50° C., such as about 20, about 25, about 30, about 35, about 40, about 45, or about 50° C.

The time required for the SEC separation will vary depending on many factors, but will generally be less than about 60 minutes, less than about 50 minutes, less than about 40 minutes, less than about 30 minutes, less than about 20 minutes, less than about 10 minutes, less than about 5 minutes, less than about 4 minutes, less than about 3 minutes, less than about 2 minutes, or less than about 1 minute. In particular, the time will be determined by the elution time of the analyte of interest. In some embodiments, the retention time is reproducible from run to run, and is relatively unaffected by changes in temperature, pH, buffer concentration, and the like.

In some embodiments, the method further comprises detecting the presence or absence of the at least one analyte in the sample. Many suitable options exist for methods of detection. In some embodiments, the detecting is performed using a refractive index detector, a UV detector, a light-scattering detector (e.g., a MALS detector), a mass spectrometer, or combinations thereof. In specific embodiments, the detecting is performed using a UV detector. Numerous detectors are available; however, a specific detector is a MALS (Wyatt DAWN™ MALS detector). Use of a dampener in the chromatography system is particularly useful for improving detection in a MALS detector. As noted above, a dampener can reduce noise in a MALS detector by trapping particulate contaminants and impeding noise induced by the pump.

### Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

To remove such interferences prior to the entry of mobile phase into a chromatographic column, the present technology utilizes a customed column flow device that acts as a trap and prevents contaminants and noise from reaching or bleeding into the SEC-MALS detector. A column bed of the customized column flow device of the present technology tolerates different pH ranges and does not get dissolved unlike silica. In addition, the column bed of the present technology does not cause an increase in MALS noise. Without wishing to be bound by theory, a particle bed column with these features (e.g., the features of the customized column flow device of the present technology) can clear the noise causing interferences by trapping them, while impeding the transient ripples induced by the pump to reduce the contribution to MALS noise. This customized column flow device, in one embodiment, is a column flow dampener.

To illustrate the advantageous of the present technology the following example is provided comparing a system without a column flow dampener and one with a column flow dampener located just before the evaluation column.

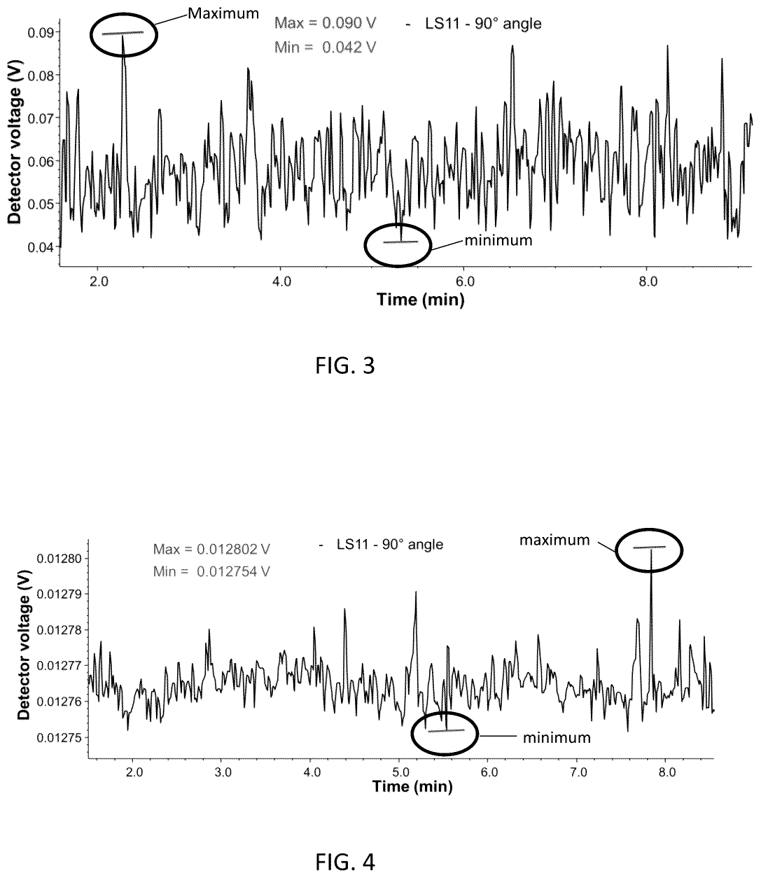

Without Dampener: FIG. 3 depicts the baseline voltage of MALS detector in a chromatography system without a dampener. Measurements were taken with clean HPLC system and filtered PBS buffer. Peak-to-peak noise is calculated by the difference between observed peak voltage at maximum and minimum peak height for the light beam illuminated at 90° angle (LS-11). Note the voltage scale on the y-axis. Even with a clean HPLC instrument and filtered (through 0.1 μm) phosphate buffered saline buffer, the baseline voltage varied from 42,000-90,000 μV with peak to peak noise of 48,000 μV and RMS noise of 7272 μV at 0.2 mL min⁻¹ flowrate.

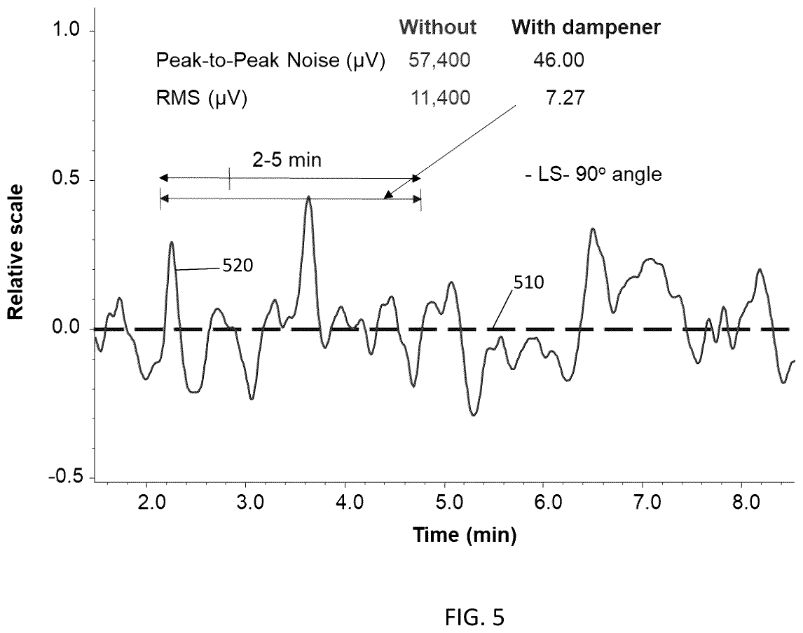

With dampener: FIG. 1 shows a schematic diagram of a chromatography system with a flow dampener (e.g., a particle bed column) positioned between the mobile phase pumps and the sample injector. In a specific example, (FIG. 2) an SEC-MALS system can be equipped with a particle bed noise dampener. An ACQUITY™ UPLC™ H-class Bio System (available from Waters Technologies Corporation) was modified with a QSM fitted with a 100 μL mixer and a particle bed dampener, FTN sample manager, column heater (30-CHA), TUV, MALS (Wyatt DAWN™ MALS detector), RI detectors. FIG. 4 depicts when a flow column dampener made of hydrophilic sorbent with particles of specific size range was installed in place of mixer (or in tandem with the mixer), the baseline voltage was between 12,802 and 12,754 μV with peak-to-peak noise of 46 μV and RMS noise of 7.27 μV (FIGS. 4 and 5) which is far below the recommended baseline voltage range of 15,000-20,000 μV for an aqueous buffer. Although an RMS noise of 100 μV is generally acceptable for major applications, detection of less abundant species and low mass loads including AAV (adeno-associated virus) characterization would require 30 μV or less.

FIG. 5 depicts a comparison of the MALS noise obtained without (520) or with the use of dampener (510). The dampener consisted of a VanGuard™ column (2.1×5 mm) and an XBridge™ HILIC column (2.1×30 mm) with 3.5 μm particles. Each column (4.6 mmX150 mm) was initially flushed with 20CV (1 column volume=˜1.8 mL) to waste before connecting it to the MALS detector. The observed baseline voltage over 2-5 min range after the flow of ˜54 mL (of 2XPBS) was used to compute the peak-to-peak noise and RMS noise (division of peak-to-peak by 6.6 as per vendor guideline). Each chromatogram is scaled against the greatest magnitude across all chromatogram data using the global scaling feature of Astra software and generated through easy graph display associated with the MALS detector. As noted in FIG. 5, the peak-to-peak noise for the system without the dampener (520) is 57,400 μV; whereas the peak-to-peak noise for the system with the dampener (510) is only 46 μV. Also contrasted in FIG. 5, the RMS of the system without the dampener (520) is 11,400 μV whereas the RMS of the system with the dampener (510) is 7.27 μV.

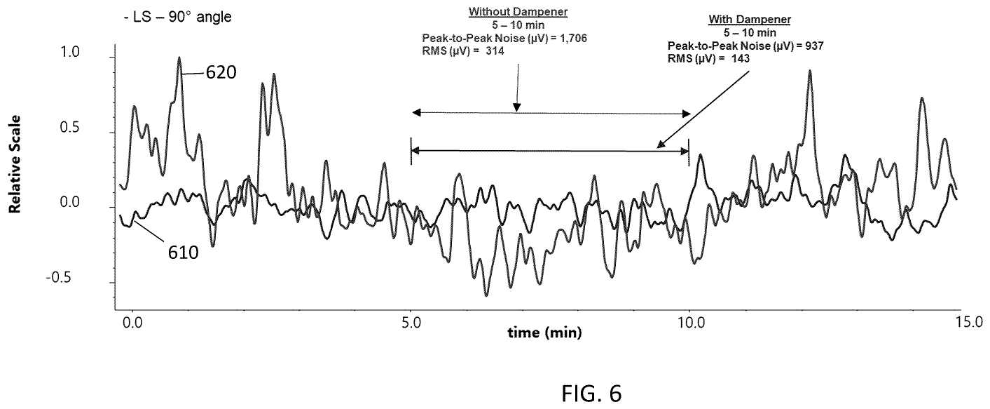

In FIG. 6, an overlay example chromatogram is presented, with (610) and without (620) a dampener located prior to the evaluation column. The evaluation column is an XBridge™ BEH™ 450 Å 2.5 μm Premier GTx Column 4.6×150 mm (available from Waters Technologies Corporation). The dampener used (for the results with a dampener) is an XBridge™ 3.5 μm HILIC particle bed in a VanGuard™ 2.1×5 mm column coupled in series to a 2.1 mm×30 mm column having XBridge™ 5 μm HILIC particle bed. For the separation without a dampener (620), a 100 μL mixer (standard with ACQUITY™ UPLC™ H-Class Bio System instruments) was used. Note that in the present technology, the mixer is replaced with the dampener. As can be seen in FIG. 6, RMS noise with the dampener (610) was at least ⅓ the RMS noise without the dampener (620).

The dampener serves the dual purpose of trapping contaminant and transient ripples in the pump. The dampener has the general properties of: pH tolerance and stability, cannot be a source of MALS noise, and appropriate placement in the flow path of the chromatography system (e.g., a UHPLC system). A single particle bed column, or multiple particle bed columns connected in series, can be used as a dampener.

In this application, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A chromatographic system comprising:
one or more mobile phase pumps;
a sample injector fluidically coupled through a flow path to the one or more mobile phase pumps;
a dampener positioned in the flow path between the one or more mobile phase pumps and the sample injection device;
a chromatographic column comprising an inlet and an outlet, wherein the inlet of the chromatographic column is fluidically coupled to the sample injection device; and
a detector coupled to the outlet of the chromatographic column.

2. The system of claim 1, wherein the dampener comprises one or more particle bed columns comprising packed particles.

3. The system of claim 2, wherein the packed particles comprise hydrophilic particles.

4. The system of claim 2, wherein the packed particles have a particle size from about 1.7 μm to about 30 μm.

5. The system of claim 2, wherein the one or more particle bed columns has an inner diameter from about 2 mm to about 5 mm; and wherein the one or more particle bed columns has a length from about 5 mm to about 30 mm.

6. The system of claim 1, wherein the chromatographic column comprises a size exclusion chromatography (SEC) sorbent.

7. The system of claim 1, wherein the one or more packed bed columns comprise a first packed bed column and a second packed bed column connected in series.

8. The system of claim 1, wherein the detector is a multi-angle light scattering (MALS) detector.

9. The system of claim 8, wherein the dampener is configured to reduce RMS baseline noise of the mobile phase to less than 100 μV or less than 30 μV in the MALS detector.

10. The system of claim 1, further comprising a heater in thermal communication with the chromatographic column.

11. A method of performing chromatography on a sample, the method comprising passing the sample through a chromatography system as described in claim 1.

12. The method of claim 11, wherein the sample comprises a macromolecule.

13. The method of claim 11, wherein the sample comprises a biological polymer.

14. The method of claim 11, wherein the sample is passed through a size exclusion chromatographic column to a multi-angle light scattering detector.
